(19) United States
(12) Patent Application Publication
(10) Pub. No.: US 2019/0260807 A1
(43) Pub. Date: Aug. 22, 2019

(54) LOCAL ROUTING OF MEDIA STREAMS

(71) Applicant: T-Mobile USA, Inc., Bellevue, WA (US)

(72) Inventor: Christopher H. Joul, Bellevue, WA (US)

(21) Appl. No.: 16/226,317

(22) Filed: Dec. 19, 2018

Related U.S. Application Data
(60) Provisional application No. 62/710,384, filed on Feb. 16, 2018.

(51) Int. Cl. H04L 29/06

(52) U.S. Cl. CPC H04L 65/1016; H04L 65/1006; H04L 65/105; H04L 65/1046

(57) ABSTRACT

An IP Multimedia Subsystem (IMS) is implemented to support a 5^{th}-Generation (5G) cellular communication network. The IMS is configured to detect when local routing between two cellular communication devices may be desirable, based at least in part on the physical proximity of the devices to. If the IMS determines that local routing is desirable, the IMS interacts with the 5G network to create a media bearer that is routed through a User Plane Function (UPF) that is common to both of the devices. More specifically, the IMS communicates with the Policy Control Function (PCF) of the 5G network to request a policy of local routing for a new media bearer. The IMS then requests creation of the media bearer. The 5G network responds by creating the new media bearer in accordance with the previously requested policy.

This application claims priority to a co-pending, commonly owned U.S. Provisional Patent Application No. 62/710,384 filed on Feb. 16, 2018, and titled “IMS Using Localized Routing for 5G,” which is herein incorporated by reference in its entirety.

### BACKGROUND

Modern cellular communication networks often include IP Multimedia Subsystems (IMSs) for delivering IP multimedia services. Services can relate to many different types of communications, such as texting/messaging, conferencing, voice, video, and so forth. Some IMS services may communicate various types of real-time content, such as live video and/or audio that is transmitted as it is captured. When communicating media such as this between two devices, it is desirable to avoid or reduce the latency that might be introduced by network communications between devices.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating an example cellular communication system in which the described techniques may be implemented.

FIG. 2 is a call flow diagram illustrating techniques for establishing local routing of IMS media streams.

FIG. 3 is a flow diagram illustrating an example method of establishing local routing of IMS media streams.

FIG. 4 is a block diagram illustrating relevant high-level components of a network computing device that may be used to implement various of the components described herein.

### DETAILED DESCRIPTION

The infrastructure of a wireless communications carrier may include an IP Multimedia Subsystem (IMS). IMS provides services such video streaming, audio/video conferencing, chat, multi-party gaming, etc. Many IMS services involve communicating data streams representing media such as audio and video.

An IMS may be used in conjunction with a network core such as a 5^{th}-Generation (5G) network core, to support a cellular communication network. In a 5G network, user-plane packet routing and forwarding are performed by a computational entity referred to as a User Plane Function (UPF). A 5G network may have multiple UPFs, which may be centrally located or may be distributed in different geographic areas.

An IMS of a 5G system such as this may be configured to recognize situations in which a media stream or other data stream is being established between UEs that are in relatively close proximity to each other, such as within the coverage of a single cell tower or within some larger area having shared resources. When the IMS recognizes this situation, it requests the network core to route a newly created media stream through a local UPF that is near the UEs, rather than through a centrally located UPF. Generally, an attempt is made to select a UPF that is geographically and/or logically between the UEs, or to select the UPF that results in the shortest communication path or least communication latency between the UEs.

By allowing the IMS to control the use of a localized UPF for IMS media, the need to bring the media back to the network core can be avoided, thus reducing backhaul costs and reducing service latency. Examples of how this can be used include looping user-to-user calls within an office of a campus and locally handling a call to use the Internet instead of managed backhaul trunks.

By allowing IMS signaling to use localized UPF, the entire IMS infrastructure can be located physically close to the access network or cell site. This can be used to enhance existing services by minimizing signaling backhaul and reducing latency. It can also be used to enable new services such as localized media functions (e.g., video) in a stadium environment, reducing setup and teardown of latency for real-time services, reducing latency of adding and removing users to a group call service, and so forth.

The IMS specifies local routing using a 5G procedure known as “Application Function Influence on Traffic Routing,” as defined by 3GPP TS 23.501, paragraph 5.6.7, where the IMS (or a component of the IMS) acts as an Application Function (AF). In accordance with this procedure, after establishing a Packet Data Unit (PDU) session with a User Equipment (UE), the IMS sends a policy request to a policy controller, referred to in 5G systems as a Policy Control Function (PCF), of the 5G network core. The policy request indicates that localized routing is preferred for a new media stream that will be created for the PDU session. The request specifies the traffic that is to be affected by identifying the UE, the local network of the UE, the PDU Session, and the IMS application that supports the traffic. The PCF responds by creating a policy that applies to the identified PDU session.

After the policy request is acknowledged by the PCF, the IMS requests the 5G network core to create an IMS media bearer, and specifies an Access Gateway (AGW) of a network that is local to the UE. In the processes of creating the new media bearer, applicable PCF rules are evaluated and, if appropriate in light of current network conditions, the network selects the rule that was previously provided by the IMS and creates the media bearer in accordance with that rule. As a result, the new media bearer is created so that it uses a network that is local to the UE, through a UPF that is geographically near the UEs, such as by being colocated with a base station to which at least one of the UEs is attached.

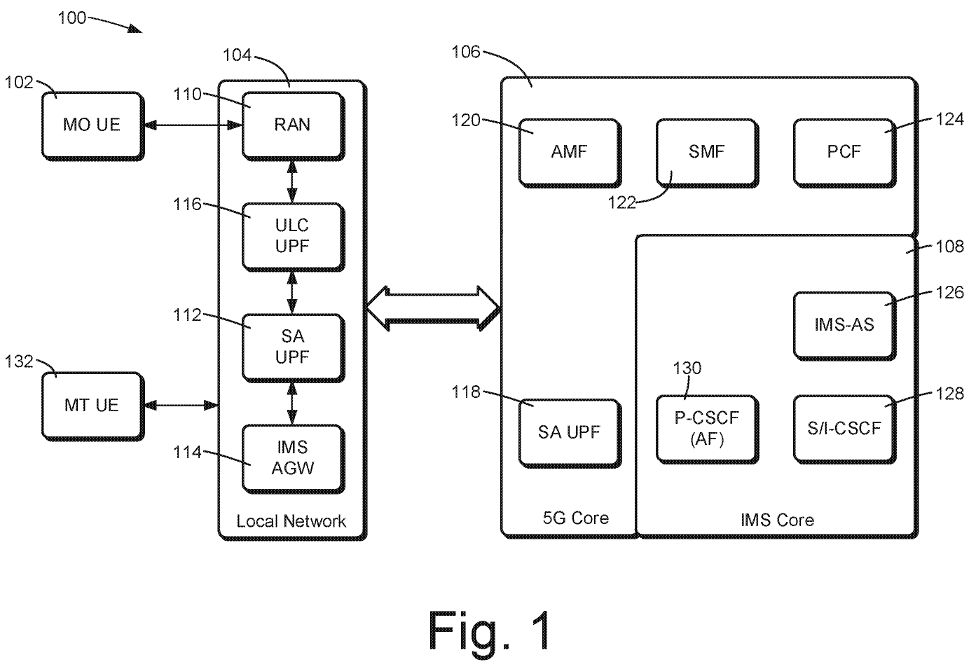

FIG. 1 illustrates an example 5G cellular communication system 100, which may be provided and/or supported by a wireless communications carrier or other service provider. The system 100 includes a User Equipment (UE) 102, a local network 104, a 5th-Generation (5G) network core 106, and an Internet Protocol (IP) Multimedia Subsystem (IMS) core 108. The system 100 may be configured to provide services for multiple users and corresponding UEs 102. In this example, the UE 102 is also described as an originating UE (MO UE) 102.

Each UE 102 comprises a cellular communication device configured to communicate over a wireless, cellular communication network, including, without limitation, a mobile phone (e.g., a smart phone), a tablet computer, a laptop computer, a portable digital assistant (PDA), a wearable computer, a television, a desktop computer, a game console, a set top box, a home automation component, a security system component, and so forth. In this sense, the terms “communication device,” “wireless device,” “wireline device,” “mobile device,” “computing device,” and “user equipment (UE)” may be used interchangeably herein to describe any communication device capable of performing the techniques described herein.

In addition to the examples above, communication devices may comprise various types of devices that are embedded in objects and equipment, such as in-home automation equipment, automobiles, electronic book reading devices, computing devices, etc., and including various other things or objects that can send and receive data using either wired or wireless networks.

The local network 104 is a sub-network of nodes that are physically close to each other. For example, the local network 104 may include nodes of a cell, or nodes of a group of cells with common connectivity. Common connectivity may be the result of deployment constraints (e.g. fiber cluster), or service needs (e.g. stadium, campus). As another example, the local network of a particular UE may include components and services that are located within an area surrounding the UE, or in an area that is covered by neighboring cell towers. As another example, the local network of a UE may comprise components and services that are dedicated to an organization of which the UE is a part. As yet another example, the local network may include components and services that are accessed through a single IMS Access Gateway (AGW).

The local network 104 includes one or more Radio Access Networks (RANs) 110, which are used for communications to and from UEs. The local network 104 also has a local Session Anchor (SA) UPF 112 and an IMS AGW 114.

The system 100 may have multiple local AGWs and UPFs, corresponding to different local networks. Local UPFs and corresponding AGWs may be geographically distributed to be physically near different local networks and UEs. For IMS communications, each local network is accessed through a corresponding IMS AGW.

The local network 104 also has an Uplink Classifier (ULC) UPF 116, which steers data traffic in accordance with network policies. In this example, the user-plane traffic is directed through the local SA UPF 112 and control-plane signaling is routed through a central SA UPF 118.

In addition to the central SA UPF 118, The 5G network core 106 has an Access Mobility and Management Function (AMF) 120, a Session Management Function (SMF) 122, and a Policy Control Function 124. The AMF 120 provides services relating to registration, reachability, mobility management, and connection management. The SMF 122 performs session management. The PCF 124 provides network routing rules, subscription information for policy decisions, and other functions.

The IMS core 108 includes an Application Server (AS) 126, referred to here as an IMS-AS 126. IMS may support multiple services, which are provided by respective IMS application servers.

The IMS core 108 has one or more Call Session Control Functions (CSCFs) that receive and process requests from UEs and that perform call session control within the IMS. The CSCFs may include a Serving CSCF (S-CSCF) and an Interrogating (I-CSCF), referred to in combination as an S/I-CSCF 128, which work together to receive and respond to call requests, to communicate with application servers, and to implement other functionality as defined by IMS protocols and standards.

The IMS core 108 also has an IMS Proxy CSCF (P-CSCF) 130, which provides an entry port to the IMS core 108 and acts as a Session Initiation Protocol (SIP) proxy server for the UE 102. As will be described in more detail below, the P-CSCF 130 may be configured to perform functions of a 5G Application Function (AF).

Arrows that are shown between components of the local network illustrate local communications being performed through the local SA UPF 112, with a terminating UE (MT UE) 132.

Note that FIG. 1 shows components and/or functions that are most relevant to the subject at hand, and that the system 100 may have many other components and/or functions. Each of the described functions may be performed by a corresponding computing entity, such as a computer or other hardware device, a computer program or other type of software, by firmware, by a virtualized application or function, or by any other means.

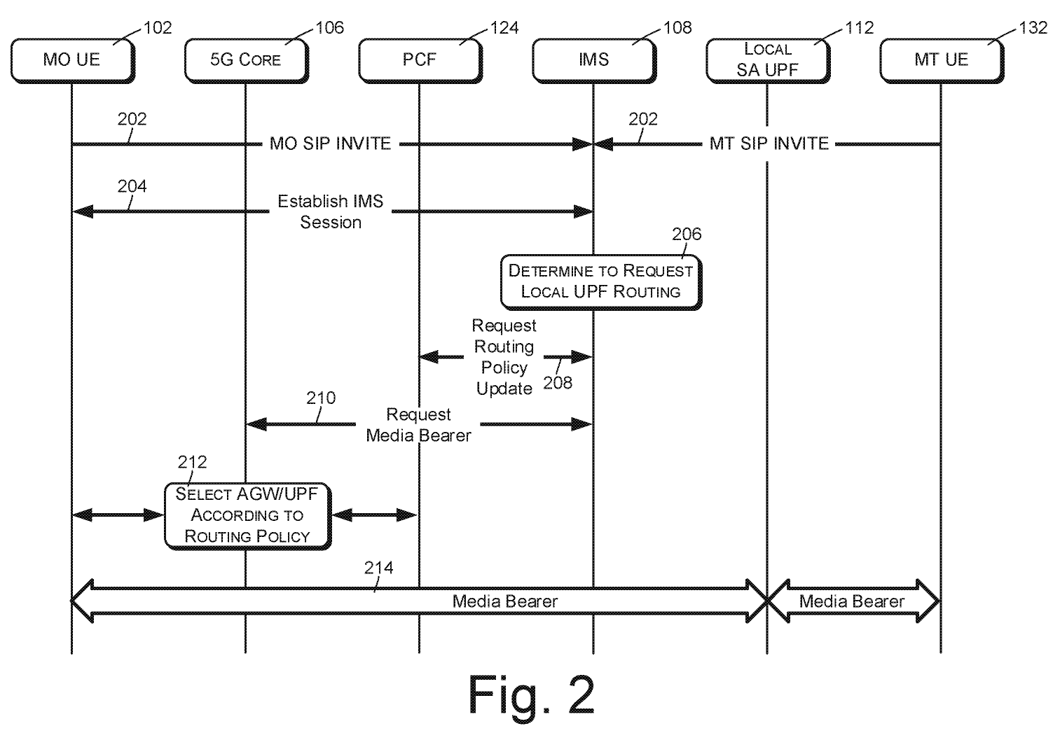

FIG. 2 illustrates a high-level call flow that may occur in certain embodiments in order to establish local IMS media communications between the MO UE 102 and the MT UE 132 of FIG. 1. In FIG. 2, communicating components or entities are listed along the top, with a corresponding vertical line extending downward. Communications are indicated by arrows that extend from and to the vertical lines corresponding to the entities from which the communications originate and terminate, respectively. Communications occur in order from top to bottom. Double-headed arrows indicate bidirectional communications, such as a request and a subsequent response. A block beneath a component or entity indicates an action performed by that component or entity.

FIG. 2 illustrates the most relevant communications and may omit other communications that occur in practice but that are less relevant to the topics at hand Such other communications may include communications that both precede and follow the illustrated communications, communications that occur in time between the illustrated communications, and communications that occur between components or entities that are not specifically shown.

At 202, the IMS core 108 receives a Session Initiation Protocol (SIP) INVITE request from the originating UE (MO UE) 102 or the terminating device (MT UE) 132. Reception of the SIP INVITE initiates creation of a PDU session.

At 204, the UE 102 and the IMS core 108 communicate to establish the PDU session. Although not shown, the UE 102 may also communicate with various components of the 5G core when setting up a session.

At 206, the IMS core 108 determines whether conditions are appropriate to request localized routing for a media stream or other data stream that is about to be established. This may be determined in some embodiments based on the physical proximity of the UEs. In some cases, the locations of the UEs may be known, and the determination may be made based on this information. In some cases, the IMS core 108 may evaluate the IP addresses of the MO UE 102 and the MT UE 132, and may consider UEs within the same subnet to be physically near each other. As yet another example, subscription information of the UEs may indicate that the UEs are those of a single organization, and the IMS core 108 may therefore conclude that the UEs are near each other.

The IMS core 108 may also determine that local routing is applicable based on service configuration for the MO UE 102 (i.e. always for this service) or presence of a local routing header (added by the P-CSCF 130) in the SIP INVITE message.

The determination of whether localized routing is desirable may be performed within the IMS core 108 by the P-CSCF 130 or by the IMS-AS 126.

In FIG. 2, it is assumed that the MO UE 102 and the MT UE 132 are physically near each other, and that localized routing is being or has been requested.

In response to determining that localized routing is desirable, the IMS performs the 5G procedure known as “Application Function Influence on Traffic Routing,” as defined by 3GPP TS 23.501, paragraph 5.6.7, where the IMS core 108 (or a component of the IMS such as the P-CSCF 130 or IMS-AS 126) acts as an Application Function (AF). Subsequent communications of FIG. 2 are in accordance with that procedure.

At 208, the IMS core 108 communicates with the PCF 124 to request the creation or update of a routing policy for a new media stream. Specifically, the IMS core 108, acting as an AF, sends a policy authorization request to the PCF 124. The request specifies a Data Network Access Identifier (DNAI), which is an identifier of the local network 104. The request specifies the traffic that is to be affected and indicates that local routing is should be given preference for the specified traffic. The request is performed using an N5 interface between the IMS core 108 and the PCF 124.

In response to receiving this request, the PCF 124 transforms information of the request into a policy that applies to the current IMS session, and provides the policy to the SMF 122.

At 210, the IMS core 108 communicates further with the 5G core network 106 to request the creation or modification of a media bearer for the current session. Among other information, this request specifies the IP address of the IMS AGW 114 of the local network 104. This request is processed by various components of the 5G network core 106.

In some embodiments, the media bearer request may comprise a Modify PDU Session request sent from the IMS core 108 to the 5G network core 106. The 5G core responds to the request in accordance with 3GPP standards, resulting in the creation of the requested media bearer.

At 212, the media bearer is created according to applicable policies. The previously created policy is treated by the 5G network core 106 as being an applicable option, and is potentially selected so that the IMS traffic is routed through a UPF 112 that is near the MO UE 102 and MT UE 132. At 214, the media bearer has been established through the local SA UPF 112 to the MT UE 132.

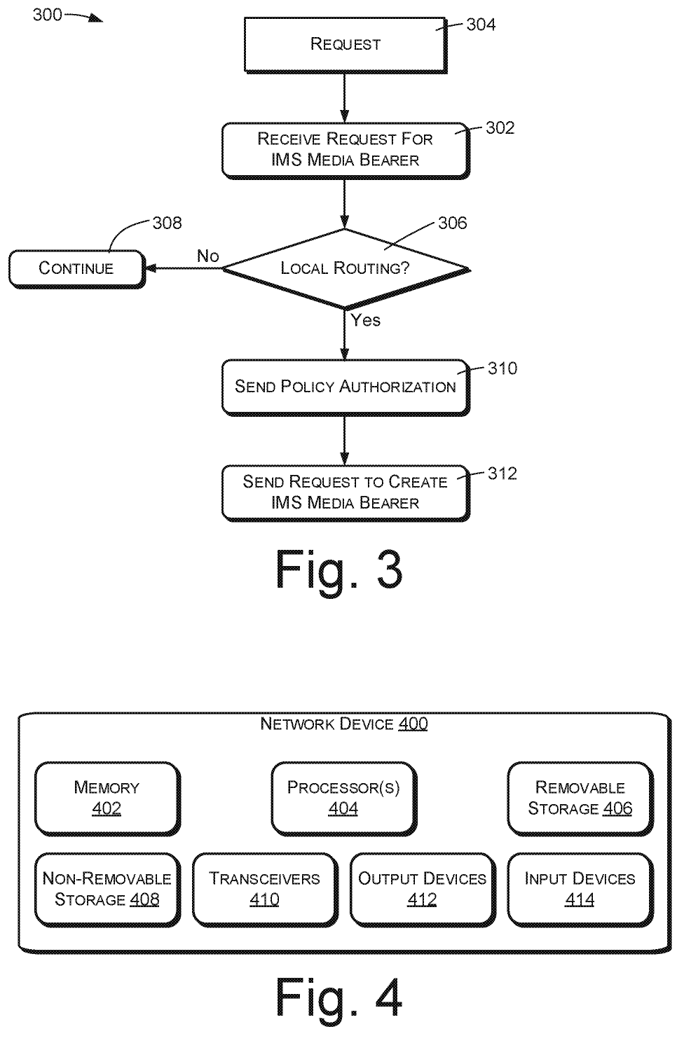

FIG. 3 illustrates an example method 300 of creating an IMS media carrier that uses local routing. In certain embodiments, the method 300 is performed by one or more computing devices or other components that are associated with or are part of an IMS core, such as by one or more CSCFs of an IMS core and/or one or more IMS application servers, as shown in FIG. 1. In embodiments described herein, the IMS core has a centrally located UPF and multiple local UPFs that are geographically distributed for use in respectively corresponding local networks.

The IMS core may be implemented, maintained, and supported by a wireless communications carrier or other service provider, such as a cellular communications carrier, and may be configured as part of a 5G network. The IMS core and/or the described method 300 may also be used in other environments.

An action 302 comprises receiving a request 304 to create an IMS media bearer between a first cellular communication device and a second cellular communication device. The request may originate with one of the cellular communication devices, from an IMS application server (IMS-AS), or from another component.

An action 306 comprises determining whether the first and second cellular communication devices are geographically proximate, and whether local routing will be requested. The IMS-AS may determine that the first and second cellular communication devices are proximate based on subscription information of the subscriber, the service configuration of the subscriber (i.e. always for this service), presence of a local routing header (added by a P-CSCF of the IMS) in a SIP INVITE message, etc. Proximity may also be determined by analyzing known network topologies, which may indicate the geographic locations of the base stations to which the devices are attached. In some cases, the number of network hops between the first and second devices may be used as a proxy for distance. When the number of network hops is below a threshold, for example, the devices are considered to be geographically proximate.

In some implementations, the action 306 may comprise determining that the first and second devices are within a predetermined distance of each other. The locations of the devices may be determined by IP-address-based geolocation, as one example, where the IP addresses of the devices are used to determine approximate device locations. As another example, the devices may report their locations based on GPS or other information available to the devices. When using geolocation, the action 306 may comprise determining that the first and second devices are within about 100 meters of each other.

As yet another example, subscription information may indicate that the devices are part of an organization, and the IMS-AS may infer from this that the devices are near each other and/or within the same local network. In some cases, the subscription information may explicitly specify that certain devices are to use local routing. In yet another example, network topology may be analyzed to determine the proximity of the cells to which the devices are attached.

In situations in which the first device is in a first cell of a cellular communication network and the second device is in a second cell of the cellular communication network, the action 306 may be based at least in part on the geographic proximity of the first and second cells. For example, the action 306 may comprise determining whether the devices are within the same cell of a communication network, within adjacent cells of the communication network, or within cells that are within a threshold distance or network hops of each other, based on known network topologies and/or known locations of cells and base stations. More specifically, for first and second devices that are in first and second cells, respectively, the action 306 may comprise determining whether the first and second cells are geographically proximate, such as being within a threshold distance of each other.

If it is determined in the action 306 that the first and second devices are not geographically proximate, an action 308 is performed of continuing with normal procedures for establishing a media bearer.

In response to determining that the first and second devices are proximate to, the IMS initiates and performs the 5G procedure known as “Application Function Influence on Traffic Routing,” as defined by 3GPP TS 23.501, paragraph 5.6.7. Actions 310 and 312 of FIG. 3 summarize that procedure.

The action 310 is performed in response to determining in the action 306 that the first and second devices are physically near. The action 310 comprises sending a policy authorization request to a PCF of the 5G network core, where the policy authorization specifies and authorizes local UPF routing for a IMS media bearer that will be established between the first and second devices. The policy authorization request may also specify one or more local networks that contain the first and second devices. Local networks may be specified by Data Network Access Identifiers (DNAIs) corresponding to one or more local networks that include the first and second devices.

In some implementations, the actions 310 and/or 312 may be performed by the IMS-AS 126, acting as a 5G AF. This may be the case, for example, when the decision to request local routing is made by the IMS-AF based on subscription information of the first and second devices. In other implementations, the actions 310 and 312 may be performed by the P-CSCF 130, acting as a 5G AF, in response to a request from the IMS-AS 126. In some cases, the P-CSCF 130, rather than the IMS-AS 126, may make the determination that local routing will be requested.

The action 312 comprises sending a request to the 5G network core to create a new IMS media bearer. This request specifies an AGW corresponding to a UPF that can be used for local routing of IMS signals. Generally, this reflects selection of a UPF that is geographically or logically proximate to the first and second devices. In some embodiments, the action 312 may include selecting a UPF based at least in part a length of a communication path between the first and second devices through the UPF. That is, the UPF resulting in the shortest communication path between the first and second devices is selected.

In response to this request, the SMF 122 communicates with the PCF 124 to determine appropriate policies and to select a policy based on current conditions. The new IMS media bearer is then created in accordance with this policy. Assuming that the policy resulting from the action 310 is selected, the 5G network core creates the IMS media bearer in accordance with the policy authorization previously provided from the IMS, so that the IMS media bearer is communicated between the first and second devices by routing through the specified UPF.

FIG. 4 illustrates a component level view of a telecommunication network device 400 capable of implementing components of a telecommunication network, including components shown in FIG. 1 such CSCFs, application servers, and various other components of the IMS core, the 5G core, and the local network.

The network device 400 may have system memory 402 that stores various executable components and data for implementing the method 300 of FIG. 3. The network device 400 may further comprise processor(s) 404, a removable storage 406, a non-removable storage 408, transceivers 410, output device(s) 412, and input device(s) 414, any or all of which can be communicatively connected via a communications bus (not shown).

In various examples, the system memory 402 is volatile (such as RAM), non-volatile (such as ROM, flash memory, etc.) or some combination of the two. In some examples, the processor(s) 404 is a central processing unit (CPU), a graphics processing unit (GPU), or both CPU and GPU, or any other sort of processing unit.

The network device 400 also includes additional data storage devices (removable and/or non-removable) such as, for example, magnetic disks, optical disks, or tape. Such additional storage is illustrated in FIG. 4 by removable storage 406 and non-removable storage 408. The system memory 402, removable storage 406 and non-removable storage 408 are all examples of non-transitory computer-readable storage media.

In some examples, the transceivers 410 include any sort of transceivers known in the art. For example, transceivers 410 may include a radio transceiver that performs the function of transmitting and receiving radio frequency communications. Also, or instead, the transceivers 410 may include other wireless or wired connectors, such as Ethernet connectors or near-field antennas. The transceivers 410 may facilitate connectivity between a public network, such as a packet-switched access network (not shown), and one or more other devices of a telecommunication network.

In some examples, the output devices 412 include any sort of output devices known in the art, such as a display, speakers, a vibrating mechanism, or a tactile feedback mechanism. The output devices 412 also include ports for one or more peripheral devices, such as headphones, peripheral speakers, or a peripheral display.

In various examples, the input devices 414 include any sort of input devices known in the art. For example, the input devices 414 may include a camera, a microphone, a keyboard/keypad, or a touch-sensitive display (such as the touch-sensitive display screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although features and/or methodological acts are described above, it is to be understood that the appended claims are not necessarily limited to those features or acts. Rather, the features and acts described above are disclosed as example forms of implementing the claims.

What is claimed is:

1. A method performed by an IP Multimedia Subsystem (IMS) of a 5th-Generation (5G) communication network, wherein the 5G communication network has at least one centrally located User Plane Function (UPF) and multiple local UPFs that are geographically distributed, the method comprising:
receiving a request to create an IMS media bearer between a first cellular communication device and a second cellular communication device;
determining that the first cellular communication device and the second cellular communication device are geographically proximate;
in response to determining that first cellular communication device and the second cellular communication device are geographically proximate, sending a policy authorization to a Policy Control Function (PCF), wherein the policy authorization requests local UPF routing for the IMS media bearer; and
sending a request to a 5G network core of the 5G communication network to create the IMS media bearer, wherein the 5G network core routes the IMS media bearer through one of the local UPFs based at least in part on the policy authorization.

2. The method of claim 1, further comprising selecting the one of the UPFs based at least in part a length of a communication path between the first and second cellular communication devices through the one of the UPFs.

3. The method of claim 1, wherein:
the first cellular communication device is in a first cell of the 5G communication network;
the second cellular communication device is in a second cell of the 5G communication network; and
determining that the first cellular communication device and the second cellular communication device are geographically proximate comprises determining that the first and second cells are geographically proximate.

4. The method of claim 1, wherein determining that the first cellular communication device and the second cellular communication device are geographically proximate is based at least in part on subscription information of the first cellular communication device and the second cellular communication device.

5. The method of claim 1, wherein sending the policy authorization is performed by an Application Server (AS) of the IMS.

6. The method of claim 1, wherein sending the policy authorization is performed by a Proxy-Call Session Control Function (P-CSCF) of the IMS.

7. A method comprising:
receiving a request to create an IP Multimedia Subsystem (IMS) media bearer between a first device and a second device;
determining that the first device and the second device are geographically proximate;
in response to determining that the first device and the second device are geographically proximate, sending a policy authorization to a policy controller, wherein the policy authorization authorizes local routing for the IMS media bearer; and
sending a request to a network core to create the IMS media bearer, wherein, based at least in part on the policy authorization, the network core routes the IMS media bearer through a User Plane Function (UPF) that is proximate to the first and second devices.

8. The method of claim 7, wherein determining that the first device and the second device are geographically proximate is based at least in part on a number of network hops between the first device and the second device.

9. The method of claim 7, wherein:
the first device is in a first cell of a cellular communication network;
the second device is in a second cell of the cellular communication network; and
determining that the first device and the second device are geographically proximate is based at least in part on geographic proximity of the first cell and the second cell.

10. The method of claim 7, wherein determining that the first device and the second device are geographically proximate is based at least in part on first subscription information associated with the first device and second subscription information associated with the second device.

11. The method of claim 7, wherein the request specifies an IMS Access Gateway (AGW).

12. The method of claim 7, wherein sending the policy authorization is performed by an IMS Application Server (AS).

13. The method of claim 7, wherein sending the policy authorization is performed by an IMS Proxy Call Session Control Function (P-CSCF).

14. An IP Multimedia Subsystem (IMS) comprising:
one or more processors; and
one or more non-transitory computer-readable media storing computer-executable instructions that, when executed by the one or more processors, cause the IMS to perform actions comprising:
receiving a request to create an IMS media bearer between a first cellular communication device and a second cellular communication device;
determining that the first and second cellular communication devices are within a predetermined distance of each other;
in response to determining that the first and second cellular communication devices are within the predetermined distance of each other, sending a policy authorization to a 5th-Generation (5G) network core, wherein the policy authorization authorizes local User Plane Function (UPF) routing for the IMS media bearer; and
sending a request to the 5G network core to create the IMS media bearer.

15. The IMS of claim 14, wherein the request specifies an IMS Access Gateway (AGW).

16. The IMS of claim 14, wherein:
the first cellular communication device is in a first cell of a cellular communication network;
the second cellular communication device is in a second cell of the cellular communication network; and
determining that the first and second cellular communication devices are within the predetermined distance of each other is based at least in part on locations of the first and second cells.

17. The IMS of claim 14, wherein determining that the first and second cellular communication devices are within the predetermined distance of each other is based at least in part on subscription information.

18. The IMS of claim 14, wherein determining that the first and second cellular communication devices are within the predetermined distance of each other is performed by an IMS Application Server (AS).

19. The IMS of claim 14, wherein determining that the first and second cellular communication devices are within the predetermined distance of each other is performed by an IMS Proxy Call Session Control Function (P-CSCF) the IMS.

20. The IMS of claim 14, wherein:
determining that the first and second cellular communication devices are within the predetermined distance of each other is performed by a Proxy Call Session Control Function (P-CSCF); and
sending the policy authorization is performed by the P-CSCF.
